(19) United States
(12) Patent Application Publication
(10) Pub. No.: US 2006/0062551 A1
(43) Pub. Date: Mar. 23, 2006

(54) Method for converting DVD captions

(75) Inventor: Chung-Chih Tung, Taipei (TW)

Correspondence Address: WELSH & KATZ, LTD, 120 S RIVERSIDE PLAZA, 22ND FLOOR, CHICAGO, IL, 60606, US

(73) Assignee: Mitac Technology Corporation, Hsien (TW)

(21) Appl. No.: 10/943,600

(22) Filed: Sep. 17, 2004

(51) Int. Cl. H04N 5/781

(52) U.S. Cl. 386/95; 386/125

(57) ABSTRACT

A method for converting DVD captions while playing DVD films aims to convert the text of the captions to a language set by users. The method includes: accessing the captions of the film; recognizing and converting the text of the captions; translating the text; accessing the translated text file and converting the translated text file to a caption file of a desired format; and coupling the translated caption file with an image file for display on a screen.

### FIELD OF THE INVENTION

The present invention relates to a method for converting DVD captions while playing a DVD.

### BACKGROUND OF THE INVENTION

A DVD (Digital Versatile Disk) is an optical disk for storing digital images. It adopts a new generation of optical storage technology. It is substantially a faster optical disk with a greater capacity to store digital data that combines the picture quality of movies, audio effect of a compact disk (CD) and computer data. In fact, experts predict that it eventually will replace the music-CD, videotape, laserdisc, optical disk and even the computer game cartridge.

A DVD general includes three types of files, i.e. “*.bup”, “*.ifo” and “*.vob”. The “*.vob” file is the main video and audio file that contains animations, pictures and sound people see and hear from the DVD.

The “*.bup” file is the main program interacting with a DVD Video disk drive that enables users to access data from the “*.vob” file. The “*.ifo” file is the abbreviation of the “information” file aiming to record and distribute data and also contain the captions of movies.

With globalization, a growing trend nowadays, people from every country have oversea trips and travel frequently and often buy some DVD films about the folklore, native dramas, and sightseeing spots of the visited countries.

Although a DVD film has taken into account the multilingual issue during the initial design, due to data storage capacity limitation and production cost concerns, it does not include the languages of all countries.

Hence the DVD films purchased in foreign countries generally are made with captions of local language or English. For people who do not speak the foreign language or English, they cannot understand the content of the films. While caption machines have been developed to translate text language, they are not convenient in use, thus are not widely accepted.

### SUMMARY OF THE INVENTION

In view of the aforesaid disadvantages occurring to conventional techniques, the primary object of the present invention is to provide a method for converting DVD captions to transform the captions of films during playing the DVD to a language set by the user facilitate user's understanding of the film.

As the processing speed of the central processing unit (CPU) of computers has become very fast today, and the technologies of optical character recognition systems and translation software have advanced significantly, the invention aims to take these advantages and adopt them in DVD captions translation while playing DVD films.

The method for converting DVD captions according to the invention includes five main steps: 1. Access the captions of the film; 2. Recognize and convert the caption text; 3. Translate the text; 4. Access the text file and convert the text file to a desired caption file; and 5. Couple the translated caption file with an image file for displaying on a screen.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a process flow chart of the method of the invention.

FIG. 2 is a schematic view of an embodiment of the invention.

### DESCRIPTION OF THE PREFERRED EMBODIMENTS

The method for converting DVD captions of the invention aims to convert the captions of a displaying DVD, such as translating from the English language in a U.S. movie into Chinese, or the Korean language of a Korean movie into Chinese, or the Japanese language of a Japanese drama into Chinese, so that users can understand the meaning of the captions.

As the processing speed of CPU in computers are very fast now, the method of the invention takes this advantage to synchronously translate the DVD captions, while playing, into a language set by users, to help the users fully understand the content of the film in the DVD.

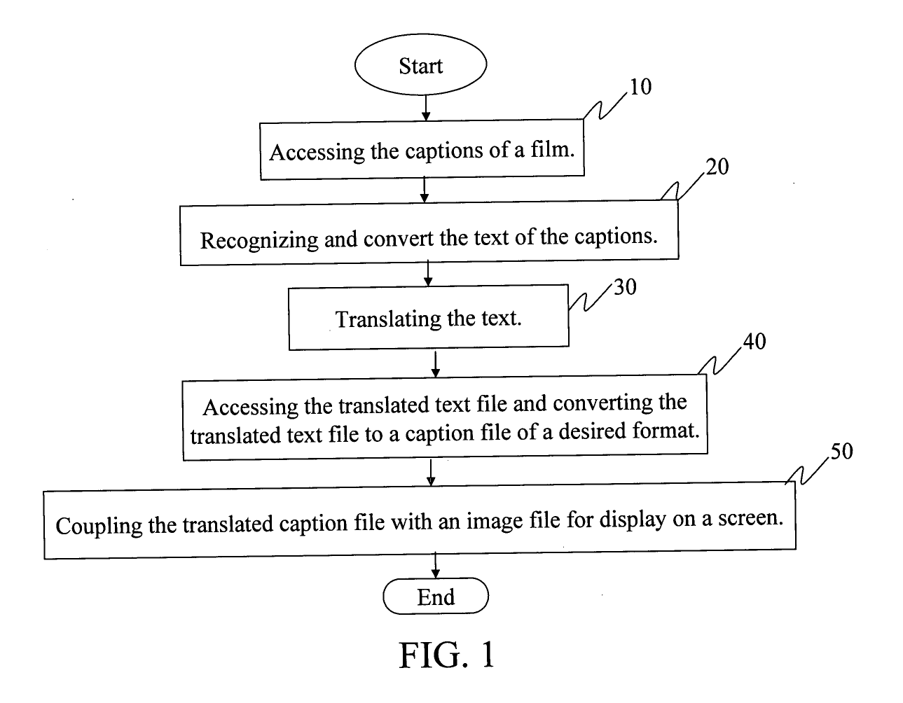

Refer to FIG. 1 for the process flow of the invention. It includes five major steps: it accesses the captions of the film (step 10); it recognizes and converts the caption text (step 20); it translates the text (step 30); it accesses the translated text file and converts the text file to a desired caption file (step 40); and it couples the translated caption file with an image file for displaying on a screen (step 50).

First, accessing the captions of the film (step 10). As the captions in the film of the DVD are existed in a “*.ifo” format, the captions to be translated are accessed and retrieved in the “*.ifo” format.

Next, recognizing and converting the caption text (step 20). This step adopts Optical Character Recognition (OCR) to recognize the text of the original captions of the “*.ifo” file, and transform them to a text file editable by the computer to facilitate text translation in the follow-up process.

Next, it translates the text (step 30). The user can set the language to be translated at the beginning of translation. Some well-developed translation software may be used to do translation among different languages. The translated sentences are stored in a text file.

Next, it accesses the text file and converts the text file to a desired caption file (step 40). As the translated sentences are in the format of the text file, the text file has to be converted to a caption file in the “*.ifo” format of the DVD for presentation while playing.

Finally, it couples the translated caption file with an image file for displaying on a screen (step 50). The translated caption file in the “*.ifo” format is coupled with an original image file for presentation together while playing.

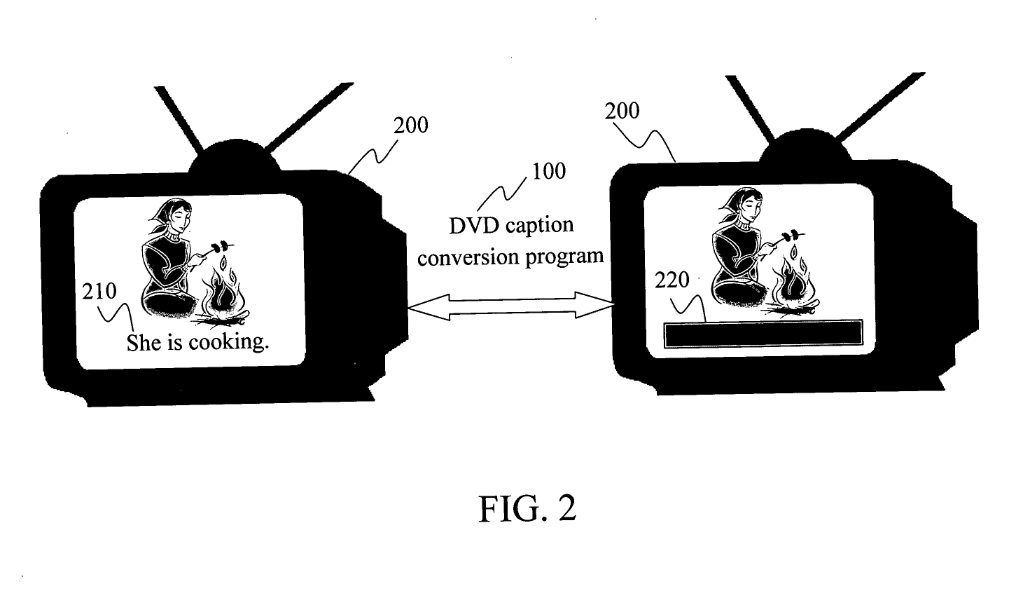

Refer to FIG. 2 for an embodiment of the invention. A DVD caption conversion program 100 is employed that covers the whole process (step 10 through 50) previously discussed. Through the DVD caption conversion program 100, an original caption 210 on a displaying screen 200, such as “She is cooking” may be converted to another caption 220 in another language like Chinese or Japanese set by a user. Therefore the user can easily understand the content of the film.

As the captions of the film are in the “*.ifo” format, selected image access software such as HyperSnap, SnagIt, Capture Professional, Camstudio or the like may be used to access the captions in the “*.ifo” format at step 10.

Moreover, the OCR system is well developed now. Hence at step 20, a desired OCR system may be used to recognize Chinese (traditional and simplified versions), Japanese and English characters.

The operation principle of the OCR system is, first, scanning the original text by the OCR approach; next, editing and verifying the text according to an image processing concept; finally, the system is separating, identifying and storing the text and image files for user editing.

For step 30 to translate the text, much advanced translation software are available now, such as Babylon Translator, LingoWare, Dr.eye or the like. They may be selectively used to do concurrent translation for sentences and dialogs between different languages, such as English and Chinese, Japanese and Chinese, Korean and Chinese.

At step 40 for accessing the text file and converting the text file to a desired caption file, a desired image process software may be used, such as: AutoCad, HyperSnap, Adobe Illustrator, Adobe Acrobat, or the like. These steps aim to convert the translated text file stored at the step 30 to a caption file in the “*.ifo” format.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A method for converting DVD captions, comprising the following steps of:
accessing a first caption file of a film;
recognizing and converting text of the first caption file;
translating the text;
accessing a translated text file from the translated text and converting the translated text file to a second caption file in a desired format; and
coupling the translated second caption file with an image file for displaying on a screen.

2. The method of claim 1, wherein the accessing a first caption file of a film is accomplished through image access software.

3. The method of claim 1, wherein the caption file is an “*.ifo” file.

4. The method of claim 1, wherein recognizing and converting the text of the first caption file is accomplished through character recognition software.

5. The method of claim 4, wherein the character recognition software is an optical character recognition system.

6. The method of claim 1, wherein translating the text is accomplished by a translation software.

7. The method of claim 1, wherein translation of the text is performed according to languages set by users.
